(19) United States
(12) Patent Application Publication
(10) Pub. No.: US 2010/0082354 A1
(43) Pub. Date: Apr. 1, 2010

(54) USER DEFINITION AND IDENTIFICATION

(76) Inventor: Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/240,957

(22) Filed: Sep. 29, 2008

(51) Int. Cl. G06Q 99/00

(52) U.S. Cl. 705/1

(57) ABSTRACT

Methods and system for user definition and identification are described. In one embodiment, a user selection criterion for an application associated with a target service provider may be accessed. User relationship information of a source user within a source service provider may be accessed. The user relationship information may define a relationship between the source user and a plurality of users of the source service provider. One or more target users of the plurality of users may be identified for the application based on the accessing of the user relationship information and the user selection criterion. Additional methods and systems are disclosed.

### BACKGROUND

A newly created application may provide various roles for its users. The roles of the users may enable certain interaction with the application, other users of the application, and other external resources related to the application.

### BRIEF DESCRIPTION OF THE DRAWINGS

Some embodiments are illustrated by way of example and not limitation in the figures of the accompanying drawings in which:

FIG. 1 is a block diagram of a system, according to an example embodiment;

FIG. 2 is a block diagram of a user identification subsystem that may be deployed within the system of FIG. 1, according to an example embodiment;

FIG. 3 is a block diagram of a user definition subsystem that may be deployed within the system of FIG. 1, according to an example embodiment;

FIG. 4 is a flowchart illustrating a method for target user identification, according to an example embodiment;

FIGS. 5-7 are flowcharts illustrating a method for target user definition, according to example embodiments;

FIG. 8 is a network diagram depicting a network system, according to an example embodiment, having a client server architecture configured for exchanging data over a network;

FIG. 9 is a block diagram illustrating an example embodiment of multiple network and marketplace applications, which are provided as part of the network-based marketplace; and

FIG. 10 is a block diagram of a machine in the example form of a computer system within which a set of instructions for causing the machine to perform any one or more of the methodologies discussed herein may be executed.

### DETAILED DESCRIPTION

Example methods and systems for user definition and identification are described. In the following description, for purposes of explanation, numerous specific details are set forth in order to provide a thorough understanding of example embodiments. It will be evident, however, to one of ordinary skill in the art that the present invention may be practiced without these specific details.

A social network service or computer-based social network application may enable a user to communicate, participate with social applications, and engage in social relationships with other users of the social network service or application. The user may have a circle of friends, a trust level with the members of the circle of friends, and a reputation within the social network.

A newly created application may use existing social relationship information of the user or otherwise “piggyback” on the existing infrastructure of the social network to create a parallel application with similar social relationships. Thus, the existing social relationship information may act as a platform for establishing new applications. For example, reputational information of the user from the social network may be used to establish a role of the user (e.g., administrator, super user, etc.) within the newly created application.

Levels of the existing social connections, aspects of the reputation system, and aspects of the access control system may be used from the social network to feed the newly created application.

In an example embodiment, information from the social network may be used to seed an ecommerce application. For example, the user may seek assistance from another user of the ecommerce application with shopping. The other user may be popular or otherwise recognized within the social network. The other user may be more directly connected to the user than others in the social network. The identified users may then assist the user with shopping based on their relationship in the social network.

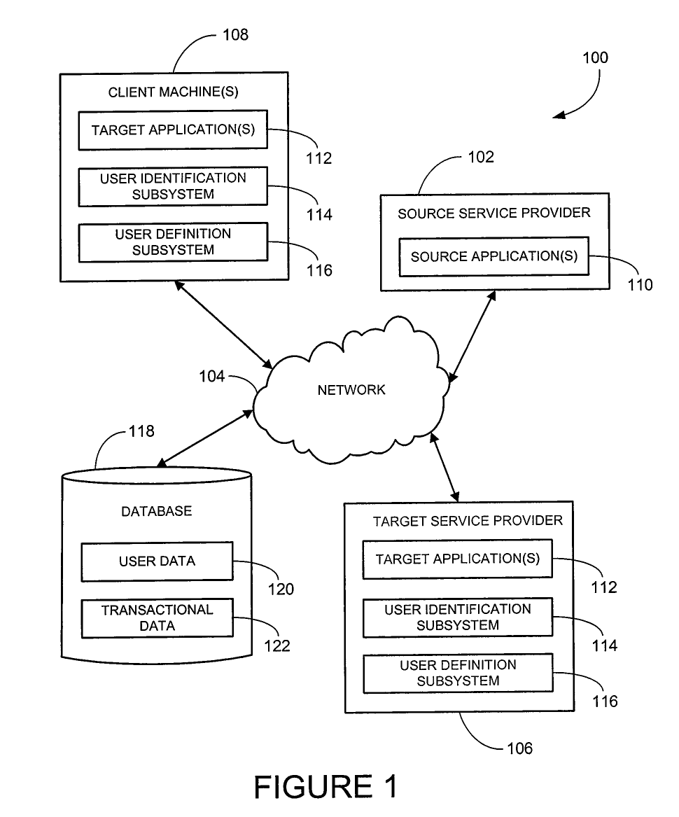

FIG. 1 illustrates an example system 100 in which information associated with a source service provider 102 may be used by a target application 112 hosted within a target service provider 106 and/or a client machine 108. The information may be obtained from the source service provider 102 from one or more source applications 110 hosted by the source service provider 102. The information may include one or more social connections, one or more aspects of the reputation system, and one or more aspects of the access control system. The information may include application performance information (e.g., a gaming score, a gaming level, gaming participation). Other types of information may be used.

The source service provider 102 may be a social network service provider (e.g., FACEBOOK, TWITTER, etc.), an online merchant or commerce service provider (e.g., EBAY), or another type of service provider. In an example embodiment, the information used from EBAY may include information indicating that users have communicated with each other, know each other, and/or have transacted with one another. The source service provider 102 may operate on a computer system maintained or controlled by a business entity.

The target service provider 106 may be a commerce service provider (e.g., EBAY), a content service provider, or a different type of provider. However, different types of service providers may also be used for the source service provider 102 and/or the target service provider 106. The source service provider 106 may operate on a computer system maintained or controlled by a business entity.

The information obtained from the source service provider 102 and used with the target service provider 106 may provide a user of the target service provider 106 with a greater degree of confidence that the person with whom the user is interacting via the target service is credible, knowledgeable, accurate, or otherwise is capable of providing information that will be useful to the user. In an example embodiment, the source service provider 102 may expose its application programmable interface (API) to enable the target service provider 106 to obtain the information.

The target application 112 may be associated with (e.g., have access to or be published by) the target service provider 106. Examples of the target application 112 include a community bookmarking application, a wiki-style user contribution application, or a recommendation information site for local schools. Other types of applications may also be used. The target application 112 may not be associated with the source service provider 102.

The network 104 over which the source service provider 102, the target service provider 106, and the client machines 108 are in communication may include a Global System for Mobile Communications (GSM) network, an Internet Protocol (IP) network, a Wireless Application Protocol (WAP) network, a Wi-Fi network, or an IEEE 802.11 standards network as well as various combinations thereof. Other conventional and/or later developed wired and wireless networks may also be used.

The target service provider 106 and/or the client machines 108 may include a user identification subsystem 114 and/or a user definition subsystem 116. The user identification subsystem 114 may identify one or more target users for a source user. The target users may meet a criterion to have a relationship with the user in the target application 112.

The user definition subsystem 116 may define an aspect for a target user when communicating with the target service provider 106. For example, the user definition subsystem 116 may define a target relationship between the source user and the target user within the target service provider 106, a target access right of the user within the target service provider 106, a new target role for the user within the target service provider 106, or the like.

Examples of the client machines 108 that the user may operate include a set-top box (STB), a receiver card, a mobile telephone, a personal digital assistant (PDA), a kiosk, a display device, a portable gaming unit, and a computing system; however other devices may also be used.

The source service provider 102 and/or the target service provider 106 may also be in communication with a database 118. The source service provider 102 and/or the target service provider 106 may each have separate databases 118 or share the database 118.

The database 118 may include user data 120 and/or transactional data 122. The user data 120 may include information regarding users of the source service provider 102 and/or the target service provider 106. The transactional data 122 may include information regarding transactions conducted with a particular service provider 102, 106.

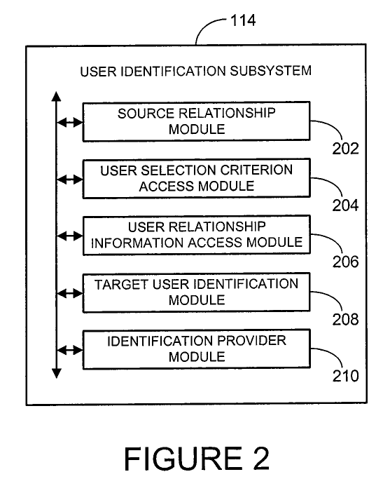

FIG. 2 illustrates an example user identification subsystem 114 that may be deployed in the target service provider 106 and/or the client machines 108 of the system 100 (see FIG. 1) or otherwise deployed in another system. The user identification subsystem 114 may include a source relationship module 202, a user selection criterion access module 204, a user relationship information access module 206, a target user identification module 208, and/or an identification provider module 210. Other modules may also be included. In various embodiments, the modules may be distributed so that some of the modules may be deployed in the target service provider 106 and some of the modules may be deployed in the client machines 108.

The source relationship module 202 determines whether source user relationship information of the source user is available to the target application 112 and/or receives identification of the source service provider 102 from the source user.

The user selection criterion access module 204 accesses a user selection criterion for the target application 112. The user selection criterion may be accessed by receiving the user selection criterion from the source user.

The user relationship information access module 206 accesses user relationship information of the source user within the source service provider 102. The user relationship information may define a relationship between the source user and a number of users of the source service provider 102. The user relationship information of the source user may be requested and, in response, the user relationship information may be received from the source service provider 102. The user relationship information may be received through an API. The user relationship information may be accessed in response to determining the source user relationship information and/or receiving the identification of the source service provider 102.

The target user identification module 208 identifies one or more target users of the number of users for the target application 112 based on the accessing of the user relationship information and the user selection criterion. The identification provider module 210 provides identification of the one or more target users to the target application 112.

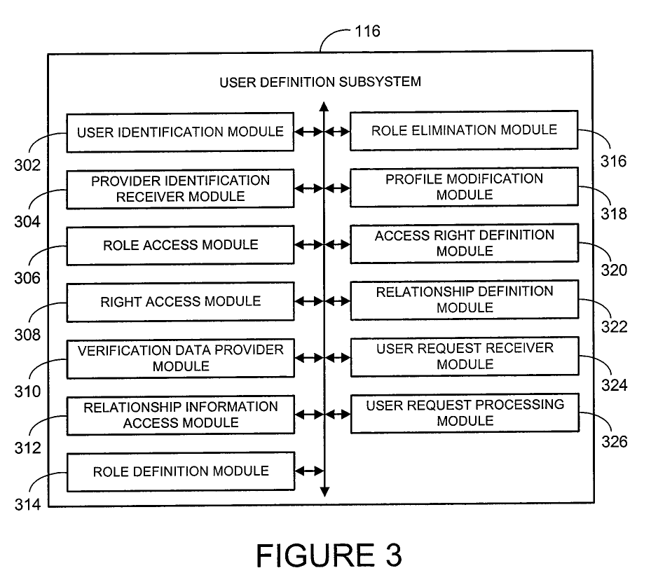

FIG. 3 illustrates an example user definition subsystem 116 that may be deployed in the target service provider 106 and/or the client machines 108 of the system 100 (see FIG. 1) or otherwise deployed in another system. The user definition subsystem 116 may include a user identification module 302, a provider identification receiver module 304, a role access module 306, a right access module 308, a verification data provider module 310, a relationship information access module 312, a role definition module 314, a role elimination module 316, a profile modification module 318, an access right definition module 320, a relationship definition module 322, a user request receiver module 324, and/or a user request processing module 326. Other modules may also be included. In various embodiments, the modules may be distributed so that some of the modules may be deployed in the target service provider 106 and some of the modules may be deployed in the client machines 108.

The user identification module 302 identifies a target user. The target user may be associated with the source application 110 and/or target application 112.

The provider identification receiver module 304 receives identification of the source service provider 102 from the user. The role access module 306 accesses a source role of the user within the source service provider 102 and/or accesses a pre-existing target role of the user within the target service provider 106.

The right access module 308 accesses a source access right of the user within the source service provider 102. The verification data provider module 310 provides verification data to the source service provider 102.

The relationship information access module 312 accesses source relationship information between the source user and the target user within the source service provider 102. The accessing of the source user relationship information may be in response to receipt of the verification data by the source service provider 102.

The role definition module 314 defines a new target role for the user within the target service provider 106 based on the source role and/or the pre-existing target role. The role elimination module 316 eliminates a pre-existing target role of the user within the target service provider 106 in response to the providing of the new target role.

The profile modification module 318 modifies a profile of the user within the target service provider 106 in response to defining the new target role. The profile may be stored in the database 118 as part of the user data 120 or may be otherwise available to the target service provider 106. The access right definition module 320 defines a target access right of the user within the target service provider 106 based on the user source access right.

The relationship definition module 322 defines a target relationship between the source user and the target user within the target service provider 106 based on the source relationship information. The user request receiver module 324 receives a user request for the target application 112. The user request processing module 326 processes the user request based on the target access right.

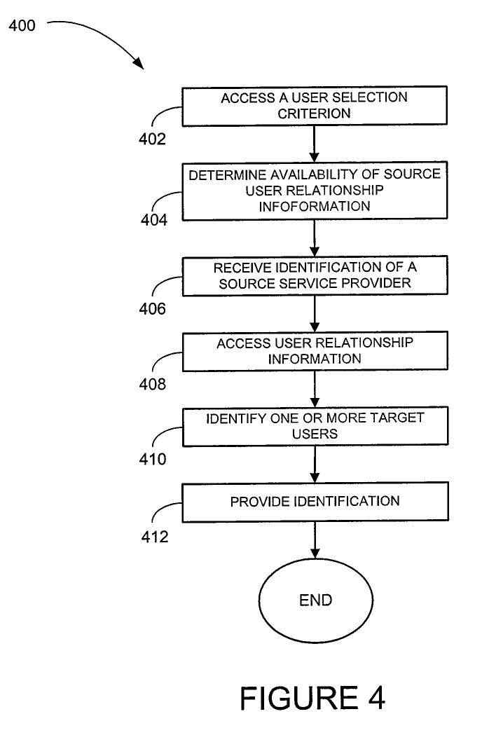

FIG. 4 illustrates a method 400 for target user identification according to an example embodiment. The method 400 may be performed by the target service provider 106 and/or the client machines 108 of the system 100 (see FIG. 1) or otherwise performed.

In an example embodiment, the user relationship information received from the source service provider 102 may be used to act as a basis or otherwise seed the target application 112. The seeding of the target application 112 may increase the number of users involved with the target application 112. The seeding of the target application 112 may increase a level of interactivity or one or more other measures of success of the target application 112.

A user selection criterion is accessed for the target application 112 associated with the target service provider 106 at block 402. The user selection criterion may include, by way of example, a particular trust level, a user reputation status, a friendship status, or the like. Other measures that may be used to identify particular candidates may also be used. The user selection criterion may be received through a user interface from a source user operating the client machine 108 or may be otherwise received. A single user selection criterion or multiple user selection criteria may be used.

A determination of whether source user relationship information of the source user is available to the target application 112 may be made at block 404. The source user relationship information may be available based on an agreement between the source service provider 102 and the target service provider 106, a general policy of the source service provider 102 to make the information available, authorization provided by the source user to the source service provider 102, or may be otherwise made available. The source user relationship information may define the relationship between the source user and a number of target users of the target service provider 106.

Identification of the source service provider 102 may be received from the source user at block 406. The identification may be provided when the target service provider 106 has multiple source service providers 102 with which it has a relationship, when the source service provider 102 does not have a prior relationship with the target service provider 106, or the like.

User relationship information of the source user within the source service provider 102 is accessed at block 408. The user relationship information may define a relationship between the source user and a number of users of the source service provider 102. For example, the user relationship information may include a trust level, a user reputation, friendship identification, or the like.

The user relationship information of the source user within the source service provider 102 may be received through an application programmable interface (API) or may otherwise be received. The user relationship information may be accessed by requesting the user relationship information of the source user within the source service provider 102 and receiving the user relationship information of the source user from the source service provider 102. The user relationship information may be accessed from the user data 120 (see FIG. 1).

At block 410, one or more target users are identified from the number of users of the target application 112 based on the user relationship information and the user selection criterion.

Identification of the one or more target users may be provided to the target application 112 at block 412. The target application 112 may then use the identification to establish relationships for the source user within the target service provider 106, provide the source user with functionality in the target application 112, or the like.

An example implementation of the method 400 may include when the target application 112 is social shopping bookmarking application. A user may be interested in various items (e.g., goods and/or services) and may tag them with bookmarks. The user may seek to identify other users with which the user can share the bookmarks. A group of users of the bookmarking application with which the user may share the bookmarks may be based on the user relationship information received from the source service provider 102, even though the bookmarking application is hosted by the target service provider 106. Other users of the bookmarking application that may share with the user bookmarks that they have identified may be based on the on the user relationship information received from the source service provider 102. The group of users and the other users may be the same users or different sets of users.

The group of users with whom the user may share tagged bookmarks may include the people with whom the user is connected in the source service provider 102. The group of users may be based on a user network within the source service provider 102. For example, the group of users may include school friends and family but not work colleagues. The group of users may be based on interaction with the source application 110. For example, the group of users may include users of the source service provider 102 that have added or played a particular game (e.g., SCRABBLE) and have achieved a certain scoring level.

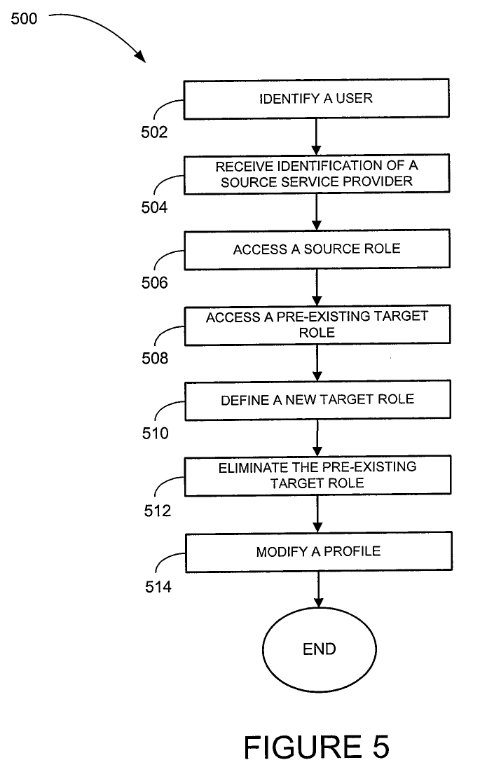

FIG. 5 illustrates a method 500 for target user definition according to an example embodiment. The method 500 may be performed by the target service provider 106 and/or the client machines 108 of the system 100 (see FIG. 1) or may be otherwise performed.

In an example embodiment, the method 500 may be used to establish a role for the user with the target service provider 106 based on a source role of the user with the source service provider 102. The user may be able to have access to certain functionality and/or have certain responsibility with the target service provider 106 based on the user's role with the source service provider 102. The adoption of a corresponding role in the target service provider 106 may encourage a user to participate with one or more of the target applications 112 of the target service provider with which the user may not otherwise be willing to participate or spend as much time.

A user associated with the target application 112 is identified at block 502. A user of the target application 112 may be identified based on a request of the user, based on selection by an operator of the target application 112, or may be otherwise identified. For example, all users of the target application 112 may be identified.

Identification of the source service provider 102 may be received from the user at block 504. For example, a user may identify one or more source service providers 102 from a number of available service providers.

A source role of the user within the source service provider 102 is accessed at block 506. The source role may define the access rights, title, responsibilities, privileges, or the like of the source user within the source service provider 102. For example, the user may be established with the source service provider 102 and have a corresponding title (e.g., community leader) and responsibilities (e.g., monitoring and banning other users).

A pre-existing target role of the user within the target service provider 106 may be accessed at block 508. The pre-existing role may define the access rights, title, responsibilities, privileges, or the like of the source user within the target service provider 106. For example, the user may be a new user with the target service provider 106 and may be obligated to make a threshold number of posts before having access to certain functionality.

At block 510, a new target role is defined for the user within the target service provider 106 based on the source role and/or the pre-existing target role. In an example embodiment, the source role may be a moderator and the target role may be a shopping assistant. However, other source roles and/or target roles may also be used. At block 512, a pre-existing target role of the user within the target service provider 106 may be eliminated based on the new target role.

A profile of the user within the target service provider 106 may be modified based on the new target role at block 514. For example, the user data 120 may be modified to reflect the updated profile.

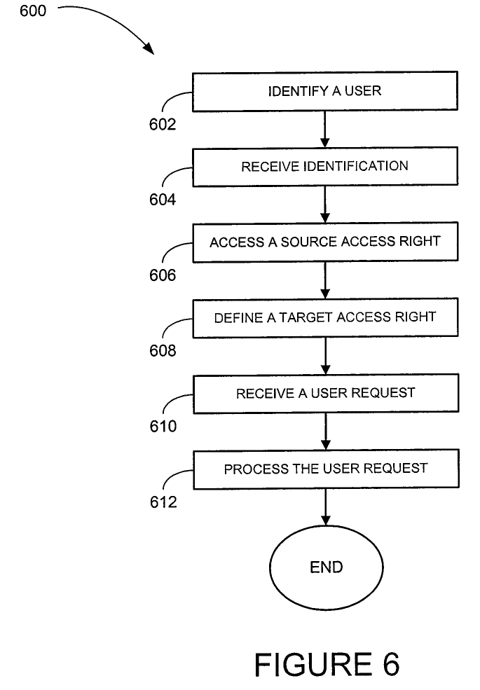

FIG. 6 illustrates a method 600 for target user definition according to an example embodiment. The method 600 may be performed by the target service provider 106 and/or the client machines 108 of the system 100 (see FIG. 1) or may be otherwise performed.

In an example embodiment, the method 600 may be used to provide a user with target access rights within the target service provider 106 based on the source access rights of the user within the source service provider 102. The access rights may include, by way of example, document modification, resource access, approving requests, rejecting requests, or the like.

A user associated with the target application 112 is identified at block 602. Identification of the source service provider 102 may be received from the user at block 604. A source access right of the user within the source service provider 102 is accessed at block 606.

At block 608, a target access right of the user within the target service provider 106 is defined based on the accessing of the user source access right. For example, a profile of the user within the target service provider 106 may be modified to provide the target access right based on accessing the source access right.

A user request for the target application 112 may be received at block 610. The user request may be a document modification request, an access request, an acceptance request, a rejection request, or the like. The user request may be received through a user interface presented on the client machine 108 or may be otherwise received. The user request may be processed based on the target access right at block 612. For example, the document may be modified based on the target access right of the user.

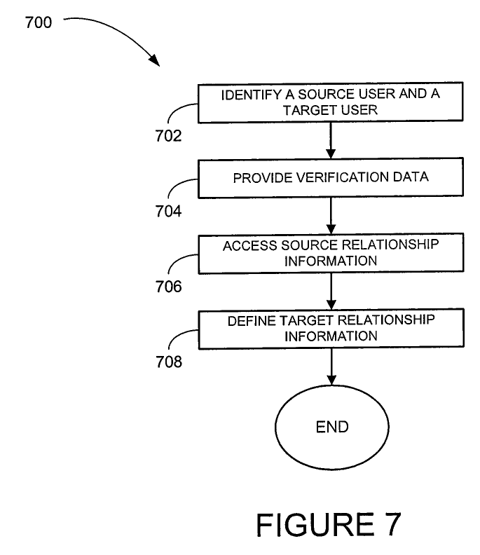

FIG. 7 illustrates a method 700 for target user definition according to an example embodiment. The method 700 may be performed by the target service provider 106 and/or the client machines 108 of the system 100 (see FIG. 1) or may be otherwise performed.

In an example embodiment, the method 700 may be used to establish a relationship between two or more users of the target service provider 106 based on their relationship within the source service provider 102. The relationship need not be identical to the relationship within the source service provider 102, but may be made appropriate for the target service provider 106.

At block 702, a source user and a target user associated with the source application 110 are identified. Verification data may be provided to the source service provider 102 at block 704.

Source relationship information between the source user and the target user within the source service provider 102 is accessed at block 706. The accessing of the source relationship information may be based on receipt of the verification data by the source service provider 102.

At block 708, a target relationship between the source user and the target user within the target service provider 106 may be defined based on the source relationship information. In an example embodiment, the source relationship may be a reader-publisher relationship and the target relationship may be a purchaser-purchaser assistant relationship. However, other types of relationships may also be used.

The methods 500, 600, 700 are shown in various embodiment to migrate user related information. However, non-user related information may be migrated from the source service provider 102 to the target service provider 106 using the methods 500, 600, 700. For example, a user network of the source service provider 102 may be selected and a subnetwork may be created out of the user network to move to the target service provider 106.

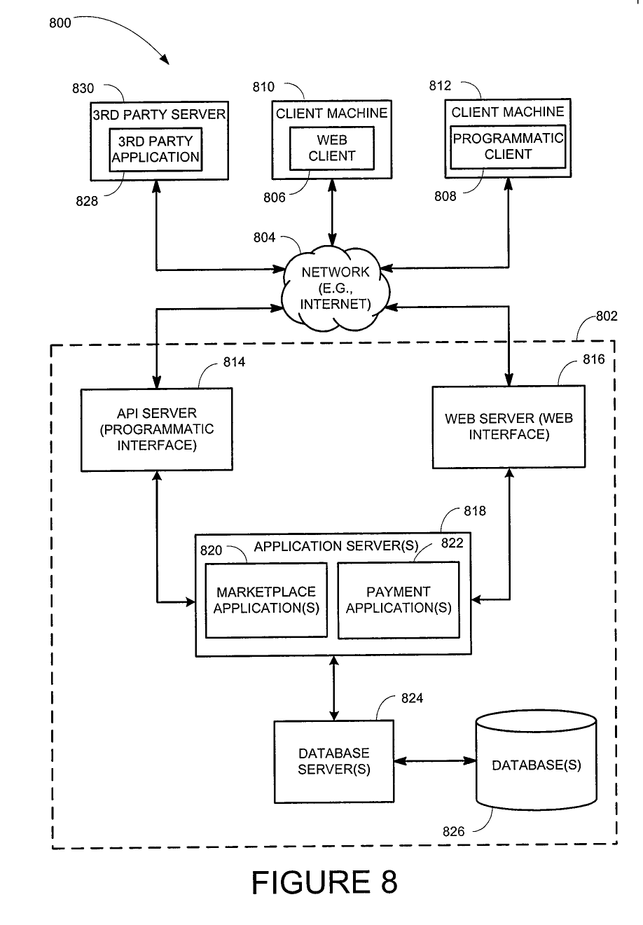

FIG. 8 is a network diagram depicting a client-server system 800, within which various embodiments may be deployed. By way of example, a network 804 may include the functionality of the network 104, the service providers 102, 106 may be deployed within an application server 818, and the client machines 108 may include the functionality of a client machine 810 or a client machine 812. The system 800 may also be deployed as part of other systems.

A networked system 802, in the example forms of a network-based marketplace or publication system, provides server-side functionality, via a network 804 (e.g., the Internet or Wide Area Network (WAN)) to one or more clients. FIG. 8 illustrates, for example, a web client 806 (e.g., a browser, such as the Internet Explorer browser developed by Microsoft Corporation of Redmond, Wash. State), and a programmatic client 808 executing on respective client machines 810 and 812.

An Application Program Interface (API) server 814 and a web server 816 are coupled to, and provide programmatic and web interfaces respectively to, one or more application servers 818. The application servers 818 host one or more marketplace applications 820 and authentication providers 822. The application servers 818 are, in turn, shown to be coupled to one or more databases servers 824 that facilitate access to one or more databases 826.

The marketplace applications 820 may provide a number of marketplace functions and services to users that access the networked system 802. The authentication providers 822 may likewise provide a number of payment services and functions to users. The authentication providers 822 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 820. While the marketplace and authentication providers 820 and 822 are shown in FIG. 8 to both form part of the networked system 802, in alternative embodiments the authentication providers 822 may form part of a payment service that is separate and distinct from the networked system 802.

Further, while the system 800 shown in FIG. 8 employs a client-server architecture, the various embodiments of the invention are of course not limited to such an architecture, and could equally well find application in a distributed, or peer-to-peer, architecture system, for example. The various marketplace and authentication providers 820 and 822 could also be implemented as standalone software programs, which need not have networking capabilities.

The web client 806 accesses the various marketplace and authentication providers 820 and 822 via the web interface supported by the web server 816. Similarly, the programmatic client 808 accesses the various services and functions provided by the marketplace and authentication providers 820 and 822 via the programmatic interface provided by the API server 814. The programmatic client 808 may, for example, be a seller application (e.g., the TurboLister™ application developed by eBay Inc., of San Jose, Calif.) to enable sellers to author and manage listings on the networked system 802 in an off-line manner, and to perform batch-mode communications between the programmatic client 808 and the networked system 802.

FIG. 8 also illustrates a third party application 828, executing on a third party server machine 830, as having programmatic access to the networked system 802 via the programmatic interface provided by the API server 814. For example, the third party application 828 may, utilizing information retrieved from the networked system 802, support one or more features or functions on a website hosted by the third party. The third party may, for example, provide one or more promotional, marketplace or payment functions that are supported by the relevant applications of the networked system 802.

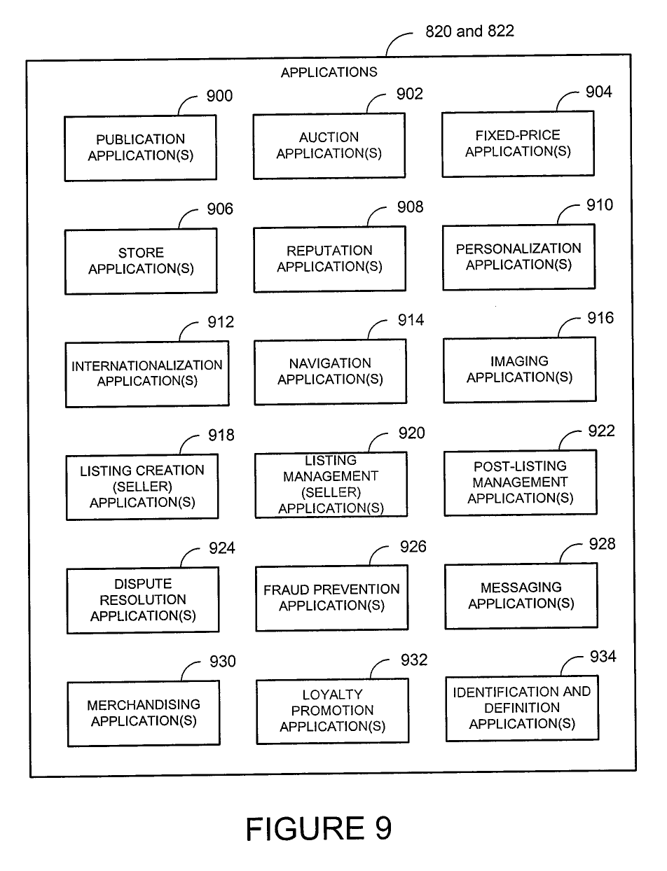

FIG. 9 is a block diagram illustrating multiple applications 820 and 822 that may be provided as part of the networked system 802 (see FIG. 8). The applications 820 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may operate to access one or more databases 826 via the database servers 824.

The networked system 802 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 820 are shown to include at least one publication application 900 and one or more auction applications 902 which support auction-format listing and price setting mechanisms (e.g., English, Dutch, Vickrey, Chinese, Double, Reverse auctions etc.). The various auction applications 902 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 904 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 906 allow a seller to group listings within a “virtual” store, which may be branded and otherwise personalized by and for the seller. Such a virtual store may also offer promotions, incentives and features that are specific and personalized to a relevant seller.

Reputation applications 908 allow users that transact, utilizing the networked system 802, to establish, build and maintain reputations, which may be made available and published to potential trading partners. Consider that where, for example, the networked system 802 supports person-to-person trading, users may otherwise have no history or other reference information whereby the trustworthiness and credibility of potential trading partners may be assessed. The reputation applications 908 allow a user, for example through feedback provided by other transaction partners, to establish a reputation within the networked system 802 over time. Other potential trading partners may then reference such a reputation for the purposes of assessing credibility and trustworthiness.

Personalization applications 910 allow users of the networked system 802 to personalize various aspects of their interactions with the networked system 802. For example a user may, utilizing an appropriate personalization application 910, create a personalized reference page at which information regarding transactions to which the user is (or has been) a party may be viewed. Further, a personalization application 910 may enable a user to personalize listings and other aspects of their interactions with the networked system 802 and other parties.

The networked system 802 may support a number of marketplaces that are customized, for example, to operate in specific geographic regions. A version of the networked system 802 may be customized for operations in the United Kingdom, whereas another version of the networked system 802 may be customized for operations in the United States. Each of these versions may operate as an independent marketplace, or may be customized (or internationalized and/or localized) presentations of a common underlying marketplace. The networked system 802 may accordingly include a number of internationalization applications 912 that customize information (and/or the presentation of information) by the networked system 802 according to predetermined criteria (e.g., geographic, demographic or marketplace criteria). For example, the internationalization applications 912 may be used to support the customization of information for a number of regional websites that are operated by the networked system 802 and that are accessible via respective web servers 816.

Navigation of the networked system 802 may be facilitated by one or more navigation applications 914. For example, a search application (as an example of a navigation application) may enable key word searches of listings published via the networked system 802. A browse application may allow users to browse various category, catalogue, or system inventory structures according to which listings may be classified within the networked system 802. Various other navigation applications may be provided to supplement the search and browsing applications.

In order to make listings available via the networked system 802 as informing and attractive, the marketplace applications 820 may include one or more imaging applications 916 utilizing which users may upload images for inclusion within listings. An imaging application 916 also operates to incorporate images within viewed listings. The imaging applications 916 may also support one or more promotional features, such as image galleries that are presented to potential buyers. For example, sellers may pay an additional fee to have an image included within a gallery of images for promoted items.

Listing creation applications 918 allow sellers conveniently to author listings pertaining to goods or services that they wish to transact via the networked system 802, and listing management applications 900 allow sellers to manage such listings. Specifically, where a particular seller has authored and/or published a large number of listings, the management of such listings may present a challenge. The listing management applications 900 provide a number of features (e.g., auto-relisting, inventory level monitors, etc.) to assist the seller in managing such listings. One or more post-listing management applications 902 also assist sellers with a number of activities that typically occur post-listing. For example, upon completion of an auction facilitated by one or more auction applications 802, a seller may wish to leave feedback regarding a particular buyer. To this end, a post-listing management application 902 may provide an interface to one or more reputation applications 908, so as to allow the seller conveniently to provide feedback regarding multiple buyers to the reputation applications 908.

Dispute resolution applications 914 provide mechanisms whereby disputes arising between transacting parties may be resolved. For example, the dispute resolution applications 914 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 926 implement fraud detection and prevention mechanisms to reduce the occurrence of fraud within the networked system 802.

Messaging applications 928 may be used to generate and deliver messages to users of the networked system 802, perhaps advising users regarding the status of listings at the networked system 802 (e.g., providing “outbid” notices to bidders during an auction process or to provide promotional and merchandising information to users). Respective messaging applications 928 may utilize any one have a number of message delivery networks and platforms to deliver messages to users. For example, messaging applications 928 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 930 support various merchandising functions that are made available to sellers to enable sellers to increase sales via the networked system 802. The merchandising applications 930 also operate the various merchandising features that may be invoked by sellers, and may monitor and track the success of merchandising strategies employed by sellers.

The networked system 802 itself, or one or more parties that transact via the networked system 802, may operate loyalty programs that are supported by one or more loyalty/promotions applications 932. For example, a buyer may earn loyalty or promotions points for each transaction established and/or concluded with a particular seller, and may be offered a reward for which accumulated loyalty points can be redeemed.

An identification and definition application 934 may be used to identify users and/or define a relationship between users of the networked system 802. The identification and definition application 934 may include the functionality of the user identification subsystem 114 and/or the user definition subsystem 116.

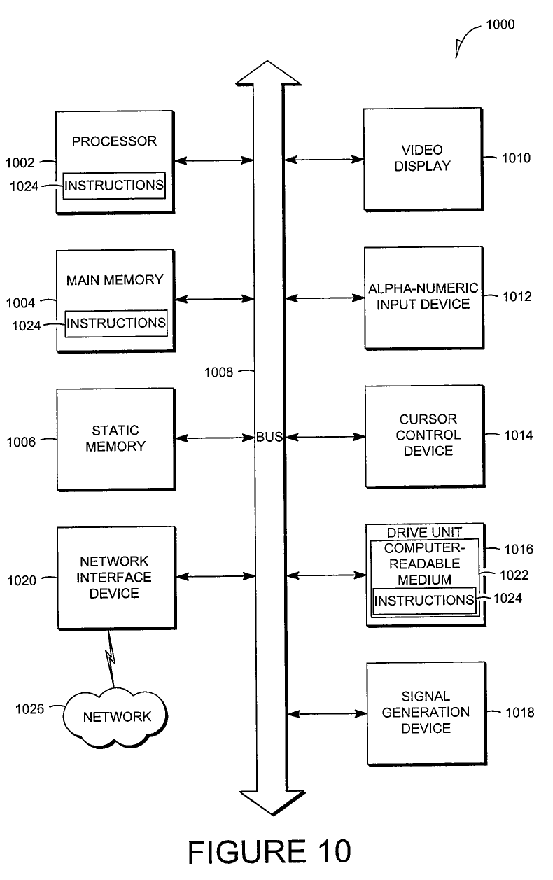

FIG. 10 shows a block diagram of a machine in the example form of a computer system 1000. A set of instructions may be executed by the computer system 1000, causing the machine to perform any one or more of the methods, processes, operations, or methodologies discussed herein. For example, the service providers 102, 106 (see FIG. 1) may operate on or more computer systems 1000. The client machine 108 may include the functionality of one or more computer systems 1000.

The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

In an example embodiment, a user selection criterion for an application associated with a target service provider may be accessed. User relationship information of a source user within a source service provider may be accessed. The user relationship information may define a relationship between the source user and a plurality of users of the source service provider. One or more target users of the plurality of users may be identified for the application based on the accessing of the user relationship information and the user selection criterion.

In an example embodiment, a user associated with an application may be identified. The application may be associated with a target service provider. A source role of the user within a source service provider may be accessed. A new target role may be defined for the user within the target service provider based on the source role.

In an example embodiment, a user associated with an application may be identified. The application may be associated with a target service provider. A source access right of the user within a source service provider may be accessed. A target access right of the user within the target source may be defined based on the accessing of the user source access right.

In an example embodiment, a source user and a target user associated with a source application may be identified. The source application may be associated with a source service provider. Source relationship information between the source user and the target user within the source service provider may be accessed. A target relationship between the source user and the target user with the target service provider may be defined based on the source relationship information.

Thus, methods and systems for user definition and identification have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a user selection criterion for an application associated with a target service provider;
accessing user relationship information of a source user within a source service provider, the user relationship information defining a relationship between the source user and a plurality of users of the source service provider; and
identifying one or more target users of the plurality of users for the application based on the accessing of the user relationship information and the user selection criterion.

2. The method of claim 1, wherein the accessing of the user selection criterion comprises:
receiving from the source user the user selection criterion for the application associated with the target service provider.

3. The method of claim 1, wherein the accessing of the reputation information comprises:
receiving the user relationship information of the source user within the source service provider through an application programmable interface (API).

4. The method of claim 1, wherein the accessing of the user relationship information comprises:
requesting the user relationship information of the source user within the source service provider; and
receiving the user relationship information of the source user from the source service provider.

5. The method of claim 1, further comprising:
determining whether source user relationship information of the source user is available to the application, the source user relationship information defining the relationship between the source user and a plurality of target users of the target service provider,
wherein the accessing of the user relationship information is responsive to the determining of the source user relationship information.

6. The method of claim 1, further comprising:
receiving identification of the source service provider from the source user,
wherein the accessing of the user relationship information is responsive to the receiving of the identification of the source service provider.

7. The method of claim 1, further comprising:
providing identification of the one or more target users to the application.

8. The method of claim 1, wherein the source service provider is a social network service provider and the target service provider is a commerce service provider.

9. The method of claim 1, wherein the user relationship information includes at least one of a trust level, a user reputation, friendship identification, or combinations thereof.

10. The method of claim 1, wherein the application is not associated with the source service provider.

11. The method of claim 1, wherein the user selection criterion includes a particular trust level, a user reputation status, a friendship status, or combinations thereof.

12. The method of claim 1, wherein the application is a community bookmarking application.

13. A method comprising:
identifying a user associated with an application, the application being associated with a target service provider;
accessing a source role of the user within a source service provider; and
defining a new target role to the user within the target service provider based on the source role.

14. The method of claim 13, further comprising:
accessing a pre-existing target role of the user within the target service provider,
wherein the defining of the new target role to the user within the target service provider is based on the source role and the pre-existing target role.

15. The method of claim 13, further comprising:
eliminating a pre-existing target role of the user within the target service provider based on the providing of the new target role.

16. The method of claim 13, further comprising:
modifying a profile of the user within the target service provider based on the defining of the new target role.

17. The method of claim 13, further comprising:
receiving identification of the source service provider from the user.

18. The method of claim 13, wherein the source role is a moderator and the target role is a shopping assistant.

19. A method comprising:
identifying a user associated with an application, the application being associated with a target service provider;
accessing a source access right of the user within a source service provider; and
defining a target access right of the user within the target service provider based on the accessing of the user source access right.

20. The method of claim 19, wherein the defining of the target access right comprises:
modifying a profile of the user within the target source to provider the target access right based on the accessing of the source access right.

21. The method of claim 19, further comprising:
receiving identification of the source service provider from the user.

22. The method of claim 19, further comprising:
receiving a user request for the application; and
processing the user request based on the target access right.

23. The method of claim 22, wherein the user request includes a document modification request, an access request, an acceptance request, a rejection request, or combinations thereof.

24. A method comprising:
identifying a source user and a target user associated with a source application, the source application being associated with a source service provider;
accessing source relationship information between the source user and the target user within the source service provider; and
defining a target relationship between the source user and the target user with the target service provider based on the source relationship information.

25. The method of claim 24, further comprising:
providing verification data to the source service provider,
wherein the accessing of the source relationship information is based on receipt of the verification data by the source service provider.

26. The method of claim 24, wherein the source relationship is a reader-publisher relationship between the source user and the target user and the target relationship is a purchaser-purchaser assistant relationship between the source user and the target user.

27. A machine-readable medium comprising instructions, which when implemented by one or more processors perform the following operations:
access a user selection criterion for an application associated with a target service provider;
access user relationship information of a source user within a source service provider, the user relationship information defining a relationship between the source user and a plurality of users of the source service provider; and
identify one or more target users of the plurality of users for the application based on the user relationship information and the user selection criterion.

28. The machine-readable medium of claim 27 further comprising instructions, which when implemented by one or more processors perform the following operations:
provide identification of the one or more target users to the application.

29. A system comprising:
a user selection criterion access module to access a user selection criterion for an application associated with a target service provider;
a user relationship information access module to access user relationship information of a source user within a source service provider, the user relationship information defining a relationship between the source user and a plurality of users of the source service provider; and
a target user identification module to identify one or more target users of the plurality of users for the application based on the accessing of the user relationship information by the user relationship information access module and the user selection criterion by the user selection criterion access module.

30. The system of claim 29, further comprising:
an identification provider module to provide identification of the one or more target users identified by the target user identification module to the application.

31. A system comprising:
a user identification module to identify a target user associated with a target application, the target application being associated with a target service provider;
a role access module to access a source role of the target user identified by the user identification module within a source service provider; and
a role definition module to define a new target role for the target user within the target service provider based on the source role accessed by the role access module.

32. The system of claim 31, further comprising:
a right access module to access a source access right of the target user identified by the user identification module within the source service provider; and
an access right definition module to define a target access right of the target user within the target source based on the accessing of the source access right accessed by the right access module.

33. The system of claim 31, further comprising:
a relationship information access module to access source relationship information between a source user and the target user within the source service provider, a source application being associated with the source service provider; and
a relationship definition module to define a target relationship between the source user and the target user with the target service provider based on the source relationship information accessed by the relationship information access module,
wherein the source user and the target user are identified by the user identification module as being associated with the source application.
